(19) United States
(12) Patent Application Publication
(10) Pub. No.: US 2013/0311783 A1
(43) Pub. Date: Nov. 21, 2013

(54) MOBILE RADIO DEVICE-OPERATED AUTHENTICATION SYSTEM USING ASYMMETRIC ENCRYPTION

(71) Applicants: Georg Heidenreich, Erlangen (DE); Wolfgang Leetz, Uttenreuth (DE)

(72) Inventors: Georg Heidenreich, Erlangen (DE); Wolfgang Leetz, Uttenreuth (DE)

(73) Assignee: SIEMENS AKTIENGESELLSCHAFT, Munich (DE)

(21) Appl. No.: 13/981,970

(22) PCT Filed: Jan. 26, 2012
(86) PCT No.: PCT/EP12/51218

§ 371 Date: Jul. 26, 2013

(30) Foreign Application Priority Data
Feb. 10, 2011 (DE) 10-2011-003-919.8

(51) Int. Cl. H04L 9/32; H04W 12/06

(52) U.S. Cl. CPC H04L 9/3247; H04W 12/06
USPC 713/176

(57) ABSTRACT

An approach for signing messages and checking the authenticity of the sender at the receiver is disclosed. For this purpose, a mobile communication network is expanded by a signature function. The transmitted message packet comprises the message and a signature of the message encrypted with a secret key. The mobile radio communication number of the transmitting device is preferably used as the public key. The receiver can check the authenticity of the message by employing a decryption method.

### PRIORITY STATEMENT

This application is the national phase under 35 U.S.C. §371 of PCT International Application No. PCT/DE2012/051218 which has an International filing date of Jan. 26, 2012, which designated the United States of America and which claims priority to German patent application number DE 10 2011 003 919.8 filed February 10, 2011, the entire contents of each of which are hereby incorporated herein by reference.

### FIELD

At least one embodiment of the present invention generally lies in the fields of mobile communications technology and information technology and generally relates to a mobile radio device or mobile network device, the use of such a device in an authentication system and for signing messages, an authentication system and an authentication and signing method, and/or a computer program product.

At least one embodiment of the present invention generally relates in particular to mobile radio devices which, in conjunction with a provider network, are able to send messages using an asymmetric encryption method in such a way from a sender to a receiver that the receiver can check whether the received message was in fact sent by the designated sender.

### BACKGROUND

Present-day, state-of-the-art systems in different application areas are usually based on a distributed information technology network architecture (for example in the manner of a client-server system), in which a plurality of users are engaged in exchanging data and messages with one another over a network. In this arrangement it is necessary to be able to ensure the trustworthiness of the exchanged messages or documents. Two aspects are primarily to be considered here: on the one hand it must be guaranteed that the message to be sent has not been corrupted or damaged on the transmission path, and on the other hand the receiver must be able to ensure that the received message also actually originates from the specified sender.

Digital signature systems and authentication systems are employed for this purpose in the prior art.

In order to guarantee the integrity of the data transmitted from an electronic transmitting device to an electronic receiving device, it is well-known in the prior art to use what are called digital signatures.

The use of digital signatures requires a so-called message digest (also called: digital fingerprint) to be generated. This is realized by providing electronic keys for encryption and decryption. In this case the assignment, allocation and administration or storage of said keys is a central and security-critical task. That is why so-called certificate authorities or other trustworthy bodies (also called: trusted third party, trust center, certification authority) are used for this purpose. It is the duty of said institution to make sure that the identity of a user and the key assigned to said user (usually the public key) is guaranteed. However, providing such a certificate authority is associated with high costs, since strict security regulations must be complied with in the administration of keys.

It is furthermore well-known in the prior art to use so-called asymmetric encryption for the secure data exchange. This is based on a key pair, including a public key and a secret/private key. In the prior art, as already mentioned above, said certificate authorities are provided by third parties, in other words independently of the sender and receiver, and consequently also independently of the transmission network. Examples of known certificate authorities are VeriSign Incorporated and the German TC Trust Center GmbH. Depending on country, however, other certificate authorities can be used here.

Specifically in the medical field or in the healthcare sector, the information technology platforms are based on the ability of the respective users (physicians and/or patients or other users) to connect to the respective system using mobile devices in order to exchange data or messages. For example, portable computers of the most diverse types, mobile radio devices or other electronic devices are used for this purpose, said devices having to interact with other computer-based entities (servers or workstations or other mobile devices) in order for example to exchange medical image data or other health-related data.

The medical application field in particular demands not only high availability in relation to the data exchange but also compliance with strict security provisions in order to ensure that security-critical, patient-specific data is not damaged or sent to the wrong recipients.

### SUMMARY

At least one embodiment of the present invention is directed to a way by which the exchange of security-critical messages can be simplified without the need to make changes to the existing terminal devices already in use. It is furthermore intended to reduce the costs for a signature and authentication system. At least one embodiment is directed to an information technology infrastructure by which the deployment of mobile radio devices for purposes of secure exchange is made possible.

At least one embodiment of the present invention provides a mobile network device. In addition, an authentication system and an authentication method are disclosed, as well as by a computer program product.

According to an embodiment of the invention, a provider network is disclosed in terms of its function and use, in addition as a certification authority. As well as the function of providing the infrastructure allowing communication between the sender and the receiver, the provider network additionally takes on the task of enabling the signing and/or authentication of messages.

An embodiment related to a computer-implemented method is described hereinbelow. Advantages, features and alternative developments mentioned herein are likewise to be applied, in particular to the mobile radio device, to the receiver, to the authentication system, and to the computer program product. It should be pointed out at this juncture that the hereinbelow-cited sequence of method steps can also be varied. Furthermore it is possible to embody the computer-implemented method in a distributed system, such that individual steps of the method can be performed on a first computer-based entity and other method steps on a second computer-based entity. Preferably the below-cited steps will be performed in part or in full on the mobile radio device acting as sender, on a receiver, and/or on the provider network.

A computer-implemented method for authenticating a sender to a receiver is provided, wherein the sender and the receiver are linked to one another in order to exchange data via electronic network devices, such as e.g. computers, smartphones, cellular telephones, laptops, wireless devices, etc. In this scheme the sender is assigned a network device on a one-to-one basis. The communication between sender and receiver is handled by way of a provider network in that the provider assigns and administers addresses as unique terminal device identifiers. The method comprises the following method steps:
Providing a machine-readable secret key of the asymmetric encryption method, which key is assigned to the sender. The secret key is part of the asymmetric encryption system. The other part is the public key, which is likewise assigned on a one-to-one basis to the respective secret key. The following applies specifically to the authentication and integrity check: The secret key is preferably used here for encrypting and the public key for decrypting. According to the invention the public key is generally accessible, is stored centrally, and must be able to be assigned to the user (client). However, alternative embodiment variants provide another assignment here. Equally it is possible, in addition to the aforementioned so-called public key method (using a generally accessible key), to apply alternative (for example symmetric) encryption methods as well. Hybrid methods (composed of symmetric and asymmetric encryption) can also be used here. The receiver is provided with the public key assigned to the respective secret key. In the preferred embodiment variant, the keys are administered by the provider network.
Providing a message on the sender. In this case it can be a message generated on the sender, for example in the form of SMS or MMS messages on a mobile radio device or text documents of a computer, or other messages in different formats (audio or visual, for example). Furthermore the message can also be a random sequence or an empty message. It is equally possible that the message is read in via an interface by a different computer-based entity and is merely made available on the sender.
Applying a signature method to the provided message or to a hash function which is applied to the provided message. In this case the provided secret key of the sender is used in order to generate a signature from the message or the hashed message. Alternatively, as well as applying a hash function, other methods can also be used to generate a target message from the original message, the target message requiring less storage space and being collision-resistant (two different original messages also have two different target messages).
Generating a message packet. The message packet is characterized in that it encompasses different elements: on the one hand the message itself and on the other hand the generated signature for the message. In alternative embodiment variants the message packet can also include further elements, such as a timestamp, for example, or other encryption elements in order to make the sending of the message even more secure.
Sending the message packet from the sender to the receiver over the provider network. According to a preferred embodiment variant the time and other parameters relating to the transmission can be configured in advance. Thus, for example, it is possible to set the time at which the message packet will be sent. The default setting is that the message packet will be sent immediately after it has been generated on the sender. However, alternatives provide the option of defining a latency period here so that the message packet will not be sent until a later time. It is likewise possible here to prefer event-driven sending, so that the receiver can request the sending of the message packet.
Receiving the message packet on the part of the receiver. After receiving the message packet the receiver applies a decryption method to the received signature of the message packet. In this case the receiver uses the provided public key. The public key is assigned, as already mentioned, to the secret key. Typically, the assignment between secret key and public key is administered by the provider network. After the decryption method has been applied, a decryption result can be extracted or provided.
In a final step, the extracted decryption result is compared with the message that was received with the received message packet at the receiver end. If the extracted decryption result is in identical agreement with the received message, it is to be assumed that the message was also indeed sent by the designated sender. In other words, the sender was able to be authenticated at the receiver. An authentication signal is optionally output at the receiver end. In an alternative embodiment variant the output of the authentication signal can be omitted and otherwise a warning signal is output which is intended to indicate that the message could not be successfully authenticated and consequently signals the error condition. In a preferred development of the invention the authentication signal can also be forwarded as a verification signal to the sender in order to indicate to the latter that his/her message has been successfully authenticated at the receiver.

The terminology used within the context of the present application is explained in more detail below.

The term “authentication” relates to an authenticity check. Its purpose is in particular to check the authenticity of the sender vis-a-vis the receiver of a message, or vice versa. The authentication therefore serves to check the identity of the other communicating party. Accordingly, the authentication method provides identification information for the purpose of verifying the sender or user (or client).

In an advantageous development of an embodiment of the invention the authentication method can also be used to sign messages. This is necessary whenever it has to be ensured that the message transmitted from the sender to the receiver was also actually generated or, as the case may be, sent by the sender. The generated signature in this case serves as a digital signature for the respective message. For this, the methods known in the prior art for generating the digital signature can be applied, such as the message digest 5 (MD5) algorithm, for example, or the secure hash algorithm 1 (SHA-1) or other known methods. In this case the message to be transmitted is, as it were, electronically “signed”, and the receiver of the message can check the electronic signature by applying his/her (public) key of the asymmetric encryption method to the signature. Otherwise, that is to say if the method is not intended for signing messages, but is only supposed to indicate the authenticity of the sender, the message can be a pure random sequence composed of digits and/or letters (instead of an actual message, so to speak). In addition, however, the message packet also includes the encrypted signature of said random sequence so that the receiver can carry out the integrity check using his/her public key.

The sender is a user of a mobile network device. In an embodiment, the sender is a mobile radio device user sending messages to a communicating party. Correspondingly, the receiver also operates a mobile radio device or can—for example mediated via such a device—use a different computer-based device in order to receive messages of the sender (for example laptop, PDA, workstation with interface to the mobile communications network). Preferably, therefore, sender and receiver are subscribers in a mobile communications network. In alternative embodiment variants, however, sender and receiver can also be users in a different network whose devices communicate via a specific protocol.

In the embodiment, the network device is accordingly a mobile radio device and yet can also be a different—possibly mobile—network device in other embodiment variants.

The “provider network” provides the infrastructure for the communication between sender and receiver. Encompassed thereby are the respective interfaces and the transmission protocol. In the embodiment, the provider network is a network of the mobile network operator to which sender and receiver belong.

There are thus different embodiments of the method according to the invention in that, depending on the configuration, individual steps of the aforementioned method steps can be performed on the sender, on the provider network, and/or on the receiver.

Preferably it is provided that the provision of the secret key, the provision of the message, the application of the signature method and the generation of the message packet, as well as the sending of the message packet, are carried out on the transmitting device, which is to say preferably on the mobile radio device of the sender. The message packet is received on the device of the receiver, where the encryption method is also applied and the decryption result is compared with the received message for agreement, and an authentication signal is output, if such provision has been made.

In an alternative embodiment, it is provided that no further changes are required to be implemented on the transmitting device, with the result that the essential functions are provided through the provider network or by the provider. Advantageously, this means that the mobile radio devices already in use (or the other network devices) can continue to be used, while only a server of the provider network (the mobile network operator) needs to be modified. In this case the generation of a computer-readable representation of a sender identification, for instance in the form of a secret key, can also be implemented on the provider and simply be sent as a message to the sender. In addition, the provided sender identification or the provided secret key can be read in, the signature method applied, the message packet generated, the message packet sent, and the message packet also received, on a computer that is associated with the provider network. Toward that end the sender sends a terminal device address (of the respective receiver) to the network operator, which can then perform all of the aforementioned steps or individual steps thereof. In a final step the network operator can also receive the message packet in place of the receiver in order to perform the further processing steps (applying the decryption method, extracting a decryption result, and comparing the extracted decryption result with the received message for agreement) ‘on behalf of’ the receiver (by proxy). The result (successful authentication signal or error signal) can then be transmitted to the receiver.

In an alternative development it is provided that said processing result generated by the provider network (successful authentication signal or error signal) is also transmitted to the sender in addition. In this embodiment variant sender and receiver can therefore be used unchanged, as previously, as far as possible, while only an add-on module (in the form of a software module and/or in the form of a hardware module) is implemented on the provider network, in particular the mobile communications network operator.

In a further embodiment of the invention, it is provided that sender and receiver do not engage in exchanging data with one another over a mobile communications network, but communicate via a different communications protocol, for example via e-mail or other internet-based protocols. In this case the e-mail address or another terminal device address serves as the public key for the signature method. Accordingly, the sender specifies the corresponding e-mail address of the receiver when sending the message packet.

According to at least one embodiment of the invention, two variants are provided for generating the signature:
Firstly, the message itself can be encrypted using the sender's secret key.
Secondly, the message itself is not encrypted directly, but instead a hash function, for example a one-way hash function, is applied to the message first. Only the thus processed (hashed) message is then signed using the secret key.

According to an embodiment of the invention, the providing of a certificate authority (as trusted third-party) can be dispensed with. Accordingly, the mobile communications network operator that is required anyway or the operator of the communications network is embodied with a further functionality, specifically the authentication and signing functionality. The communications network operator (e.g. mobile network operator) therefore takes over all or selected functions of the known but separate certificate authority in the prior art and simultaneously provides the information technology infrastructure for the communication of the network devices. Up to now, mobile network operators known in the prior art were restricted to the execution of functions of the mobile communications network, and in particular were not designed to take on signature and authentication tasks. Conversely, known certificate authorities are entrusted with the authentication function.

An embodiment of the invention proposes an authentication and signing system integrated into the computer network of the communications network operator (in particular of the mobile communications network operator). The security- and performance-related advantages, as well as the advantage of the reduction in costs, are obvious. The authentication system according to an embodiment of the invention is preferably integrated into a computer or into the computer system (usually embodied as a cloud system or network) of the (mobile network) operator. In this case the terminal device address (the cellular telephone number of the user or the latter's e-mail address, etc.) can be used as a public key. The administration of the keys and the generation of the keys can likewise be exported to the provider.

In an advantageous development it is provided that a send identifier is additionally provided which identifies the sender of the message packet. The send identifier is a unique terminal device address, for example the cellular telephone number of the mobile radio device or an e-mail address which where appropriate is processed by way of an identification function so that it can point in a one-to-one manner to the e-mail sender. The send identifier can also be a customer-specific memory address which the provider already knows and uses. In this case it is not mandatory—but merely optional—to add the send identifier to the message packet.

According to an alternative aspect of an embodiment of the invention, the send identifier can optionally be added to the message packet. This enables the receiver, after receiving the message packet, to conduct a further comparison or alignment with the received send identifier in addition to the previously provided comparison between extracted decryption result and received message. In this way the security of the authentication system can be further increased.

An advantage of the solution according to an embodiment of the invention is to be seen in that the message to be transmitted is independent of the respective format of the message. Thus, for example, text, image or video data can be transmitted. Alternatively, data in audio or other formats or arbitrary combinations of the aforementioned data formats can be transmitted, signed and authenticated and/or checked.

A further advantage is to be seen in that a embodiment of the method is modular in structure and individual functions (such as mentioned hereinabove: providing a send identifier, applying the signature method, providing the secret key, generating the message packet, sending and receiving the message packet, as well as the further processing steps of the message packet on the receiver side) are executed in separate sub-modules. Depending on the configuration, and also on load balancing criteria, these sub-modules can be relocated to the provider network. Depending on implementation, individual steps that are normally performed on the transmitting device or on the receiving device can therefore also be exported to the provider network and vice versa.

A network device is also disclosed. According to an embodiment, this is a mobile radio device for use in an authentication system, such as described hereinabove. In this case the mobile radio device (or network device) is embodied with a secure memory for the purpose of providing or storing the user-specific secret key. The secret key can be generated directly on the mobile radio device or it can be generated by another entity and then sent to the mobile radio device. The secret key is known only to the device and is user-specific. The memory is typically provided by the customer-specific SIM card.

The mobile radio device additionally includes a signature module which is embodied for applying the signature method to the message that is to be transmitted or to a hash function of the message or to a pure random sequence for the purpose of authentication. In this case the secret key from the secure memory is used to generate the signature.

In addition the mobile radio device includes a send module that is intended for generating the message packet, comprising the message and the generated signature. The send module serves for sending the message packet to a target address that is intended to identify the receiver on a one-to-one basis. The message packet is sent over the provider network.

Alternatively the functions of the signature module and/or of the send module can also be implemented on the provider network, so that only their respective result is communicated to the mobile radio device. The sending of the message packet can also be carried out by the provider network on the authority, as it were, of the mobile radio device.

As sender, the mobile radio device communicates with a receiver device over the mobile communications network. The receiver device can also be a mobile radio device or another electronic device capable of communicating with the provider network. Alternatively the network device of the sender can also be a computer-based entity that communicates with receiver devices by way of a network (internet, local area network, wide area network, etc.). According to an embodiment of the invention, in this arrangement the network is intended to be operated by a provider network or connected thereto, the latter network being developed further according to an embodiment of the invention as an authentication or signing system.

The network device, in particular mobile radio device, can be used for signing messages. Equally it can be used for authenticating the sender to a receiver.

A network device-operated electronic authentication system, intended for signing messages and/or for authenticating the sender of messages, is disclosed. In this process messages are exchanged between sender and receiver engaging in data exchange by way of a communications network. An asymmetric encryption method is applied here. A provider network administers the message exchange and the management of the keys. A plurality of network devices serving as sender and/or as receiver are connected to the system.

The receivers assigned to the authentication system serve for receiving the message packet, applying the decryption method using the public key, and comparing the decryption result with the message from the received data packet, as well as for establishing whether an authentication was successful or unsuccessful. It is also possible here to transfer the aforementioned modules and/or functions of the receiver devices in their entirety or individually to the provider network.

A computer program product is also disclosed.

A computer-implemented method is also disclosed which can be performed as a distributed system on the sender, on the provider network, and/or on the receiver. In this case the computer-implemented method can also be stored on a storage medium.

Further solutions, their developments and alternative embodiment variants are to be found in the accompanying claims.

### BRIEF DESCRIPTION OF THE DRAWINGS

In the following detailed description of the figures, example embodiments which are not to be understood as limiting are described together with their features, advantages and further alternatives with reference to the drawings, in which:

FIG. 1 shows a schematic representation according to an embodiment variant of the invention of a first network device acting as sender and engages in data exchange with a second network device acting as receiver, and

FIG. 2 shows a schematic representation of two mobile radio devices which, according to an embodiment variant, are intended for signing messages or authenticating users.

### DETAILED DESCRIPTION OF THE EXAMPLE EMBODIMENTS

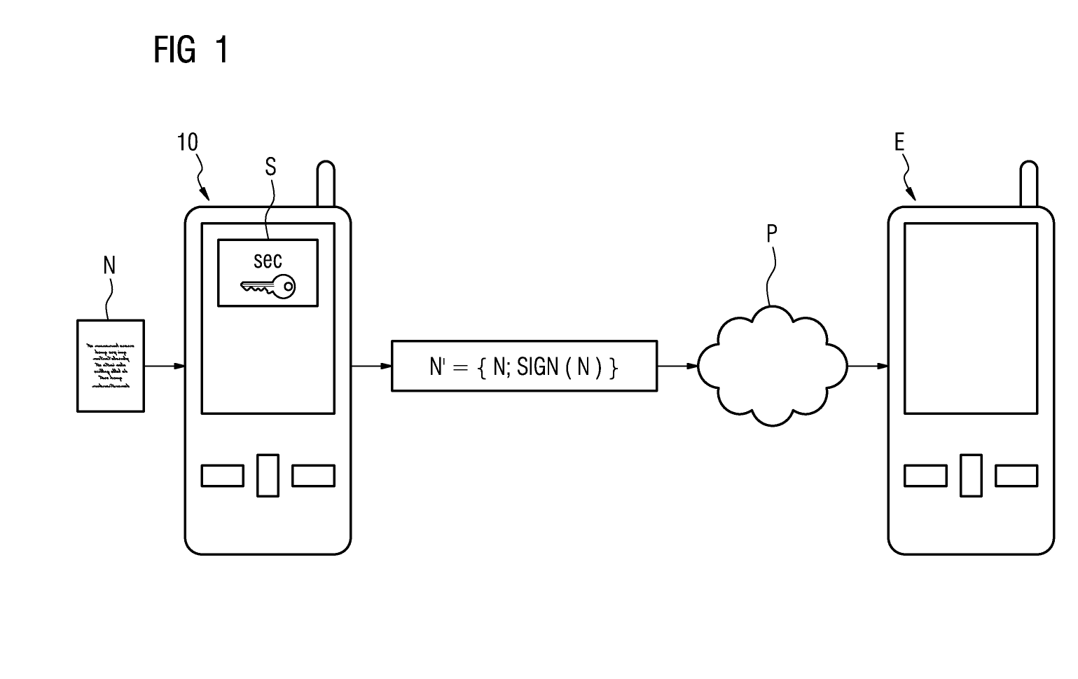

FIG. 1 shows in schematic form the solution according to an embodiment of the invention, which can be used on the one hand for signing messages N and/or for authenticating a sender of messages N, wherein the sender sends messages N from a network device, in particular a mobile radio device 10, to a receiver E.

In a first variant the proposal according to an embodiment of the invention therefore relates to an approach to signing messages N whereby they can be checked at the receiver E to verify whether the message N also actually originates from the specified sender and has not been damaged or corrupted in the interim.

Alternatively the proposal according to an embodiment of the invention can also be used exclusively for identity checking between sender and receiver, as an authentication system so to speak. Accordingly the message N can be empty or it can be a random message that is merely intended to establish the authenticity or integrity of the sender at the receiver end. In this case an asymmetric encryption method is employed using a secret key sec and a public key pub.

As already mentioned, an example embodiment relates to the use of mobile radio devices that act as sender 10 and receiver E and that engage in data exchange by way of a mobile communications network of a provider network P. Generally, in addition to providing the infrastructure to allow communication between the connected communicating parties, the provider network also includes a plurality of servers in order to be able to handle the exchange of messages.

According to an embodiment of the invention the provider network P has been developed to provide further functions for authenticating and signing messages. It therefore comprises further modules and computer-based entities, in particular a server Z, which assumes the function of a certificate authority, as is known in the prior art. The server Z comprises a data structure in which the management of the keys of the encryption method is handled. This includes in particular a data structure which in each case assigns at least one public key pub to a secret key sec in each case. Preferably this assignment is bijective, so that precisely one public key pub is assigned to each individual secret key sec. The data structure or database is administered by the central server Z of the provider network P. Alternatively the server Z can also be associated with a different system and be connected in a data exchange relationship with the provider network P via corresponding interfaces.

An alternative embodiment variant makes provision for the deployment of computer-based network devices which are engaged in data exchange with one another by way of a communications network. For example, the terminal devices could be computers communicating with one another via a corresponding e-mail functionality. The e-mail traffic is then handled via the internet and the protocols known in the prior art (from the internet protocol family, for example, the SMTP protocol, which can be based on different versions 4 or 6 of the IP protocol, or with other protocols).

As already mentioned hereintofore, according to an example embodiment variant, the mobile communications network is extended with the aim of providing further functions which are used during the exchange of messages or data between the individual mobile radio devices 10, E, etc. According to an embodiment of the invention access control is implemented during this process to ensure that only authorized users can communicate in the network. An authenticity check is additionally provided between sender and receiver so that a unique association is possible between sender and receiver of a message. Furthermore, the message is additionally linked to the sender, thereby enabling an integrity check to be performed as a further functionality. By way of the latter, functionality it can be ensured that a message has not been changed (damaged or tampered with) unnoticed on its path through the network of the network operator P.

According to an aspect of an embodiment of the invention a secure memory S, on which the secret key sec is stored, is provided on the mobile radio device acting as sender. Typically, the secret key sec is known only to the sending mobile radio device. Alternatively, however, the secret key sec can also be provided by the provider network P and forwarded to the sending mobile radio device for sending. Optionally it can be buffered.

During operation a message N is generated on the sending device or said message is read in by other entities via a corresponding interface. The message N can include data in arbitrary formats, for example text data, image data, video data, audio data or data in other formats, as well as in combinations of the aforesaid possibilities. Embodiments of the invention are not limited to a specific data format. It is also possible that the method is intended only for authenticating the sending user, so that the message N can also include a random sequence and consequently is contentless.

In a next step, the secret key sec from the memory S is then used in order to apply a signature method to the message N. In the figures the signature method is designated by the reference symbol SIGN. “SIGN(N)” therefore denotes the signed message. In order to apply the signature method, the sending network device includes a signature module 12. The signature module 12 can be provided as a software or hardware module or as a combination of both.

In addition, the sending network device includes a send module 14 which is intended for generating a message packet N′. The message packet N′ comprises the message N and in addition the signed message SIGN(N). In alternative developments the message packet N′ can also include further parameters, for example a timestamp or the like. The message packet N′ is then sent by the send module 14 by way of the provider network P to the dedicated receiver E. For this, the send module 14 can use the cellular phone number of the receiver E as address. Otherwise a unique device address of the receiver device is used for addressing the same.

According to one embodiment variant the previously cited steps are performed on the sender side, that is to say in particular directly on the sending mobile radio device 10. Alternatively, however, they can also be performed on other entities that are engaged in data exchange with the device 10. Furthermore it is also possible to perform all or individual steps of the previously described method on the provider network P, in order to have to modify the prior art mobile radio devices as little as possible. All of the functionalities can then be handled and provided on the provider network P.

There now follows a description of method steps that are performed on the receiver side.

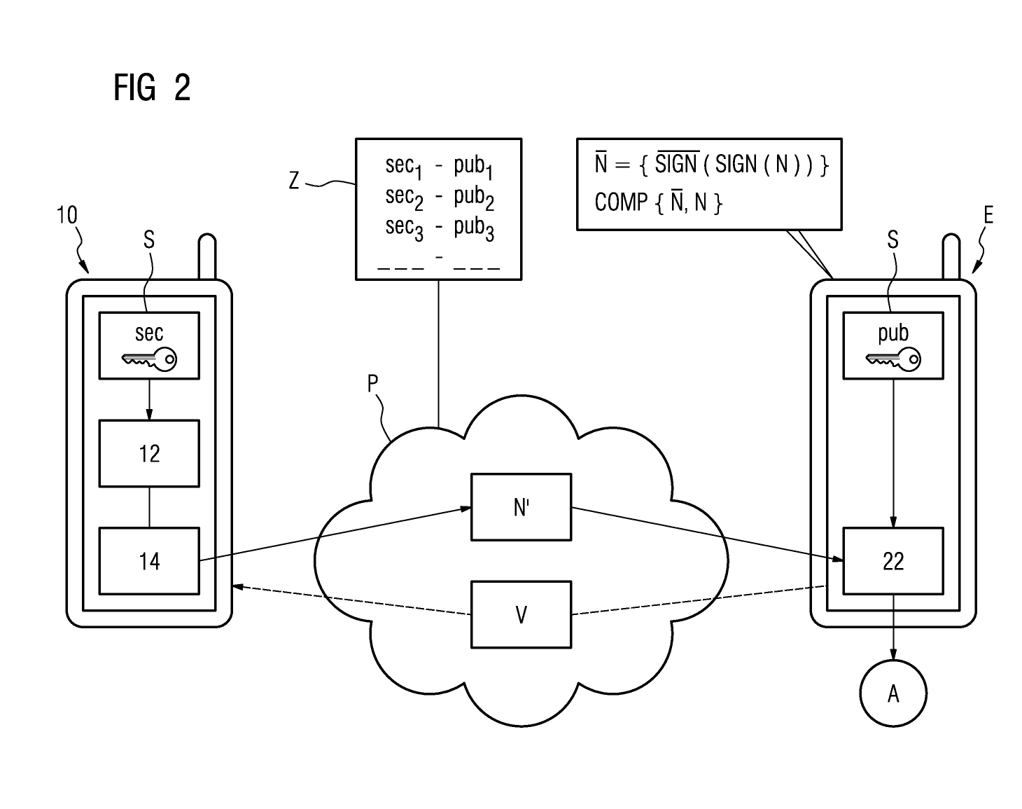

Toward that end the receiver device E is likewise embodied with a memory S in which the public key pub is stored. Preferably the public key pub is uniquely assigned to a secret key sec. For this purpose the receiver E is additionally embodied with a receive module 24 and a decryption module 22. FIG. 2 shows an embodiment variant in which the receive module 24 is integrated into the decryption module 22. Alternatively, however, they can also be embodied as separate modules (not shown). The receive module 24 (not shown) serves for receiving the message packet that was sent by the send module 14 of the network device 10. The decryption module 22 serves for applying a decryption method to the received signature of the message using the public key pub. The decryption method is designated in FIG. 1 by “{ ^{S̅I̅G̅N̅} (SIGN(N))}”. By applying the decryption method it is possible for the receiver to extract a decryption result ^{N̅}. The decryption module 22 can then compare the extracted decryption result ^{N̅} with the received message N from the message packet N′. This comparison is designated in the figures by the reference symbol “COMP{ ^{N̅},N}”. In this case the decryption method has recourse to the public key, which can be stored either directly in the receiver device or at the provider and is read in via an interface. If the comparison reveals that the extracted decryption result ^{N̅} and the message N are in identical agreement, the sender is deemed to be successfully authenticated. An authentication signal A is output accordingly.

In developments it is provided to forward the authentication signal A to further entities. Alternatively a verification signal V can also be sent to the sending network device 10 in order to indicate to the sender that the transmitted message was successfully authenticated at the receiver end. Since this is an optional procedure, it is represented in FIG. 2 by a dashed line from receiver E to the sending network device 10.

An essential aspect in the implementation of the solution according to an embodiment of the invention is that the respective network of the communications operator does not necessarily have to be restricted to the mobile communications network with mobile communications network terminal devices, but that other electronic terminal devices, for example computers and personal computers using a corresponding network protocol (for example the internet), can also be used here. Accordingly the network provider is not the mobile communications network operator, but is another entity that is embodied with the additional functionalities (authenticity check, signature, decryption and encryption, etc.).

An important advantage of an embodiment is to be seen in the fact that no additional extensive implementation provisions are required on the part of the network device user. Furthermore it is no longer necessary to conclude agreements with a third party that serves as a certification authority.

In an example embodiment variant, a send identifier is additionally provided which is intended to identify the sender's network device. Optionally the send identifier can be sent as a further parameter with the message packet N′. Preferably the send identifier is the cellular telephone number or another terminal device address. In an advantageous development of an embodiment of the invention, instead of the public key as send identifier, an additional send identifier is used. The security of the method can be increased in this way.

To conclude, an embodiment of the invention can therefore be described in summary form as follows. The unique terminal device address (for example telephone number or e-mail address—possibly with further identifying supplementary information) is used as the public key of an asymmetric electronic signature method and the use of a separate, communications-network-independent certificate authority as third party, as was necessary in the prior art, is no longer necessary for signing messages or authenticating a message sender. Accordingly the network operator is developed further in order to make these additional functionalities available. As a result the authentication and/or signature system is integrated into the provider network P which is used for the communication between sender and receiver E.

1. A network device for use in an electronic authentication system for at least one of authenticating a sender to a receiver and for signing messages by way of an asymmetric encryption method, wherein the respective messages are sendable, from the network device assigned to the sender, to the receiver via a provider network, the network device comprising:
a secure memory, configured to provide a user-specific secret key;
a signature module, configured to apply a signature method to the message or to a hash function of the message using the secret key from the secure memory to generate a signature; and
a send module, configured to generate a message packet, the message packet at least including the message and the generated signature, and additionally configured to send the message packet to the receiver via the provider network.

2. A method, comprising:
using the network device of claim 1 for signing a sender's message directed to the receiver.

3. A network device electronic authentication system for at least one of authenticating a sender to a receiver and signing messages using an asymmetric encryption method, wherein messages are exchangeable via a provider network, between the receiver and a network device assigned to the sender, the network device-operated electronic authentication the system comprising:
a plurality of the network devices of claim 1,
a plurality of receivers, each of the receivers including
at least one receive module configured to receive the message packet of the send module of the network device, and
at least one decryption module configured to
apply a decryption method to the received signature using a public key assigned to the secret key for the purpose of extracting a decryption result,
compare the extracted decryption result with the message from the received message packet and
output an authentication signal upon the comparison indicating agreement between the extracted decryption result and the message.

4. A method for authenticating a sender to a receiver, wherein messages are exchangeable between the receiver and a network device assigned to the sender, using an asymmetric encryption method, via a provider network, the method comprising:
providing a machine-readable secret key of the sender, assigned to a public key of the sender, wherein the public key is provided to the receiver;
providing a message the sender;
applying a signature method to the message or to a hash function of the message using the secret key of the sender for the purpose of generating a signature;
generating a message packet at least comprising the message and the generated signature;
sending the message packet from the sender to the receiver via the provider network;
receiving the message packet at the receiver and applying a decryption method to the received signature, using the provided public key assigned to the secret key, extract a decryption result; and
comparing the extracted decryption result with the message from the received message packet, and if the extracted decryption result and the message are in agreement, outputting a signal authenticating the sender.

5. The method claim 4, wherein a send identifier is further provided and wherein the send identifier is addable to the message packet.

6. The method of claim 4, wherein either all of the following steps or individual steps thereof are performed by the provider network:
providing a machine-readable send identifier,
applying a signature method,
generating a message packet, wherein after the respective step has been performed a result is relayed to the sender, and/or
wherein the comparison is conductable by the provider network, with a comparison result being forwarded to the receiver.

7. The method of claim 4, wherein either all of the following steps or individual steps thereof are performed on the network device:
providing a machine-readable send identifier,
applying a signature method,
generating a message packet, wherein after the respective step has been performed a result is relayed to the sender.

8. The method of claim 4, wherein the send identifier is a cellular telephone number or a terminal device address of the network device.

9. The method of claim 4, wherein the authentication signal is transmitted to the sender as the result of a successful authentication vis-à-vis the receiver.

10. The method of claim 4, wherein the network is a mobile communications network and the public key is a terminal device address.

11. The method of claim 4, wherein the network is the internet or is based thereon as a service network and wherein the public key is an email address or an IP address of the sender.

12. The method of claim 4, wherein the message comprises text and/or image data, video data, audio data and/or data in other formats, as well as a combination of different types data and/or a randomly generated numeric and/or character sequence.

13. The method of claim 4, for signing the message by the sender and for checking the signature at the receiver.

14. A computer program product having a computer program stored on a machine-readable medium for performing of claim 4 when the computer program is executed on a computer.

15. The network device of claim 1, wherein the network device is a mobile radio device.

16. The network device-operated electronic authentication system of claim 3, wherein the network device is a mobile radio device.

17. The method of claim 10, wherein the network is a mobile communications network and the public key is a cellular telephone number of the sender's mobile radio device.

18. A method for sending a message via a provider network, from a network device assigned to a sender to a receiver, the method comprising:
providing a user-specific secret key from a secure memory of the network device;
applying a signature method to the message or to a hash function of the message using the secret key provided from the secure memory, to generate a signature;
generating a message packet, via a send module of the network device, the message packet including at least the message and the generated signature; and
sending the message packet to the receiver via the provider network.

19. The method of claim 18, wherein the network device is a mobile radio device.

20. A computer program product having a computer program stored on a machine-readable medium for performing the method of claim 18 when the computer program is executed on a computer.

21. A method for authenticating a sender, wherein a message is exchangeable between the receiver and a network device assigned to the sender, using an asymmetric encryption method, via a provider network, the method comprising:
providing a public key at the receiver;
receiving a message packet at the receiver, from the network device assigned to the sender and via the provider network, the message packet including at least the message and a signature generated at the network device of the sender, the signature being generated from a signature method applied to the message or to a hash function of the message using a secret key of the sender assigned to the public key;
applying a decryption method to the received signature, using the provided public key, to extract a decryption result;
comparing the extracted decryption result with the message from the received message packet; and
outputting, upon the extracted decryption result and the message being in agreement, a signal authenticating the sender.
